(19) United States
(12) Patent Application Publication
(10) Pub. No.: US 2023/0118509 A1
(43) Pub. Date: Apr. 20, 2023

(54) VENTILATION SYSTEM FOR REDUCING INDOOR RADON CONCENTRATION

(71) Applicant: BETTERLIFE CO., LTD., Suwon-si, Gyeonggi-do (KR)

(72) Inventor: Jae Sung LEE, Seongnam-si (KR)

(73) Assignee: BETTERLIFE CO., LTD., Suwon-si, Gyeonggi-do (KR)

(21) Appl. No.: 17/049,877

(22) PCT Filed: Nov. 21, 2019
(86) PCT No.: PCT/KR2019/015997

§ 371 Date: Oct. 22, 2020

(30) Foreign Application Priority Data
Oct. 29, 2019 (KR) 10-2019-0135716

(51) Int. Cl. F24F 11/00; F24F 7/08; F24F 13/10; F24F 11/52; F24F 11/39; G05B 19/042

(52) U.S. Cl. CPC F24F 11/0001; F24F 7/08; F24F 13/10; F24F 11/52; F24F 11/39; G05B 19/042; F24F 2110/68

(57) ABSTRACT

A ventilation system that reduces indoor radon concentration includes indoor radon measuring devices installed in indoor spaces inside a building. A blowing device on an outer wall of the building or in a specific outdoor place includes an exhaust fan for exhausting air and an air supply fan for supplying outdoor air. An exhaust fan driving device drives the exhaust fan in the blowing device. An air supply fan driving device drives the air supply fan in the air blowing device. An air distribution device has upper and lower chambers and includes exhaust passages connected to one end of the exhaust fan to accommodate exhaust dampers that individually exhaust the air to the lower chamber. Air supply passages connected to one end of the air supply fan accommodate air supply dampers to supply the outdoor air and individually distribute the outdoor air to each of the specific indoor spaces.

### TECHNICAL FIELD

The present invention relates to a ventilation system for effectively reducing an indoor radon (Rn) concentration.

### BACKGROUND ART

In general, radon (Rn) is a kind of natural radioactive gas that causes alpha decay with a half-life of 3.8 days and has colorless, odorless, and inert properties. Radon mainly flows into an indoor space through cracks of a construction from the ground of the building, and may also be generated from uranium-decayed objects contained in cement, soil, and other interior and exterior materials used in building construction and flow into the indoor space.

When radon enters the lungs through the respiratory tract, radon kills cells in the lungs, thereby mainly causing cancer. Thus, the world health organization (WHO) and the U.S. environmental protection agency (USEPA) have defined radon as a major causative agent, ranked after smoking, of lung cancer and recommend to control the concentration of radon in the indoor air. Radon exists in outdoor air or groundwater, but it is exposed mostly through the indoor air, which accounts for about 95%.

In other words, due to the heaviest gas properties on the planet, once radon flows into an indoor space, radon accumulates therein without flowing out. Radon enters the lungs through human breathing and emits alpha radiation while decaying, in which the alpha radiation is the atomic nucleus of helium (He2+), which has a penetration power weaker than beta or gamma rays, but has a relatively large mass, thereby causing destruction of lung cells.

Meanwhile, although periodic ventilation or the like by a resident is mainly required to reduce radon gas flowing into the indoor space, the ventilation is rarely performed during cold winter or at night, so residents are exposed to radon gas, thereby suffering from serious damage.

In particular, since classrooms where students stay in groups have no systematic management on radon gas, the health of students is concerned. In order to solve the above problem, the government mandates a facility having reduced radon gas based on the revision of the School Health Act in which radon is measured and radon gas is maintained at about 148 Bq/m³ or less in each classroom on the first floor or below.

The related art for managing indoor radon gas is disclosed in Korean Patent Registration No. 10-1569270 (INDOOR RADON REMOVAL DEVICE WITH AIR PURIFIER). According to the above related art, an air supply pipe capable of supplying fresh air is installed to an indoor ceiling of a classroom or the like, and an air discharge pipe for sucking and discharging contaminated air is installed on the floor, so that fresh air supplied through the air supply pipe and having passed through an air purifier is supplied to the indoor space.

In addition, Korean Patent Registration No. 10-1650436 (INTEGRATED MANAGING SYSTEM FOR RADON REDUCTION FACILITIES) discloses the technology in which a stratified database is constructed as a large classification where a plurality of radon reduction facilities are classified into a plurality of categories, an intermediate classification where each category of the large classification is classified into a plurality of places, and a small classification where each place of the intermediate classification is classified into a plurality of radon influencing factors, and the radon reduction facilities are integrally managed sequentially in each category unit, each place unit, and each radon influencing factor unit by means of sequentially selecting one category at the level of the large classification, at least one place at the level of the intermediate classification, and at least one radon influencing factor at the level of the small classification, so that a lot of radon reduction facilities scattered at various places can be systematically managed and controlled while considering the characteristics of each place with respect to a radon exposure damage.

Meanwhile, domestic apartments or detached houses being built in these days have the very high sealing rate about 90%, so it is legally mandated to install mandatory ventilation equipment.

The ventilation equipment is installed with a positive pressure ventilation fan so as to be minimally affected by the number of floors and the external environment, and designed to concentrate only on indoor and outdoor air ventilation. Accordingly, some products may have an indoor negative pressure, due to internal piping installation in the process of product installation.

The houses, in which radon is released indoors more, are often found due to the above problem, on the contrary. The highest radon concentration at home is exhibited between 10 pm and 5 am. The peak of radon at home is found in the above time. The indoor space is required to be continuously ventilated during the above time, but the ventilation is not actively performed due to cooling or heating issue, and thus residents are directly exposed to radon.

### DISCLOSURE

### Technical Problem

The present invention is provided to solve the above-described problems. An object of the present invention is to provide a ventilation system for reducing indoor radon concentration, in which a plurality of indoor radon measuring devices installed in a plurality of specific indoor spaces provided inside the building is used, so as to effectively reduce radon concentration in indoor air while monitoring radon concentration information in each specific indoor space in real time, and effectively control ventilation equipment installed in the building.

### Technical Solution

To achieve the above object, an aspect of the present invention provides a ventilation system for reducing indoor radon concentration, which includes: a plurality of indoor radon measuring devices installed in a plurality of specific indoor spaces provided inside a building to measure radon concentration information data of each of the specific indoor spaces; a blowing device installed on an outer wall of the building or in a specific outdoor place and including an exhaust fan for exhausting air in each specific indoor space and an air supply fan for supplying outdoor air; an exhaust fan driving device for driving the exhaust fan provided in the blowing device; an air supply fan driving device for driving the air supply fan provided in the air blowing device; an air distribution device divided into an upper chamber and a lower chamber and including a plurality of exhaust passages connected to one end of the exhaust fan and accommodating a plurality of exhaust dampers to individually exhaust the air in each specific indoor space to the lower chamber, and a plurality of air supply passages connected to one end of the air supply fan and accommodating a plurality of air supply dampers to supply the outdoor air and individually distribute the outdoor air to each of the specific indoor spaces; a plurality of exhaust damper driving devices for driving the exhaust dampers to control a flow rate of the air discharged through the exhaust fan from an exhaust port in each specific indoor space in association with a degree of opening of each exhaust passage from full opening to full closing of each exhaust passage stepwise according to a specific ventilation control signal; a plurality of air supply damper driving devices for driving the air supply dampers to control a flow rate of the air introduced from the air supply fan to an outdoor air supply port in association with a degree of opening of each air supply passage from full opening to full closing of each air supply passage stepwise according to a specific ventilation control signal; and a ventilation control device configured to control driving of the exhaust fan driving device and the air supply fan driving device, in which the ventilation control device receives radon concentration information data of specific indoor spaces measured from the indoor radon measuring devices in real time, and operates in a primary overall ventilation mode based on the radon concentration information data, when at least one of radon concentration values of the specific indoor spaces is greater than a preset risk radon concentration reference value, to suppress radon introduced to the specific indoor spaces through a positive pressure principle according to a radon concentration value of the corresponding specific indoor space, such that an amount of air introduced into the specific indoor space is adjusted to be higher than an amount of air discharged to an outside, wherein, after the primary overall ventilation mode is operated, the ventilation control device receives radon concentration information data of the specific indoor spaces measured from the indoor radon measuring devices in real time, analyzes radon concentration changing values for each specific indoor space based on the radon concentration information data, operates in a secondary individual ventilation mode for suppressing radon introduced to each specific indoor space according to radon concentration change values for each specific indoor space, generates a specific ventilation control signal for individually controlling driving of the exhaust damper driving device and the air supply damper driving device to control a flow rate of air introduced to each specific indoor space and a flow rate of air discharged to the outside, and transmits the specific ventilation control signal to the exhaust damper driving device and the air supply damper driving device.

Preferably, each of the indoor radon measuring devices may include: an indoor radon measurement sensor module installed in each specific indoor space to measure radon concentration information data of each specific indoor space; a wireless communication module for wirelessly transmitting the radon concentration information data of each specific indoor space measured from the indoor radon measurement sensor module; and an indoor radon measurement control module configured to control an operation of the wireless communication module, such that the radon concentration information data of each specific indoor space measured from the indoor radon measurement sensor module is received in real time and transmitted wirelessly to the ventilation control device.

Preferably, the indoor radon measurement sensor module may include at least one radon measurement sensor using an ionization chamber scheme.

Preferably, in the secondary individual ventilation mode, the ventilation control device may individually control driving the exhaust damper driving device and the air supply damper driving device to allow a flow rate of air introduced to each specific indoor space to be adjusted higher than a flow rate of air discharged to the outside, such that radon introduced to each specific indoor space through a positive pressure principle according to a radon concentration change value for each specific indoor space is suppressed.

Preferably, when a first specific indoor space corresponding to a change value of increasing radon concentration among change values of radon concentration in the specific indoor spaces is present in the secondary individual ventilation mode, the ventilation control device may generate a specific ventilation control signal for controlling driving of a first exhaust damper driving device and a first air supply damper driving device corresponding to the first specific indoor space to increase a flow rate of air introduced to the first specific indoor space and decrease a flow rate of air discharged to the outside according to the change value of increasing radon concentration.

Preferably, when a second specific indoor space corresponding to a change value of decreasing radon concentration among the change values of radon concentration in each specific indoor space is present, the ventilation control device may generate a specific ventilation control signal for controlling driving of a second exhaust damper driving device and a second air supply damper driving device corresponding to the second specific indoor space to decrease a flow rate of air introduced to the second specific indoor space and increase a flow rate of air discharged to the outside according to the change value of decreasing radon concentration.

Preferably, after the primary overall ventilation mode or the secondary individual ventilation mode is operated, the ventilation control device may receive radon concentration information data of the specific indoor spaces measured from the indoor radon measuring devices in real time, and control driving of the exhaust fan driving device and the air supply fan driving device to decrease a current supply amount of air introduced to each specific indoor space and increase a current exhaust amount of air discharged to the outdoors, when the radon concentration value of the specific indoor space is smaller than the preset risk radon concentration reference value, based on the radon concentration information data.

Preferably, when the radon concentration value of the specific indoor space is smaller than the preset risk radon concentration reference value, the ventilation control device may decrease the current supply amount of air introduced to each specific indoor space and increase the current exhaust amount of air discharged to the outdoors, in which the ventilation control device may control driving of the exhaust fan driving device and the air supply fan driving device such that a supply amount of air introduced to each specific indoor space is adjusted to be higher than an exhaust amount of air discharged to the outside so as to suppress radon introduced to each specific indoor space through the positive pressure principle.

Preferably, the ventilation control device may control driving of the exhaust fan driving device and the air supply fan driving device, in which the ventilation control device may calculate a time required for at least one of radon concentration values of the specific indoor space to the preset risk radon concentration reference value, and operate in the primary overall ventilation mode, when the calculated required time reaches within a preset reference time range, to suppress radon introduced to each specific indoor space through the positive pressure principle according to the calculated required time, such that a supply amount of air introduced to each specific indoor space is adjusted to be higher than an exhaust amount of air discharged to the outside.

Preferably, at least one heat exchange member may be provided between the upper chamber and the lower chamber provided in the air distribution device to allow heat exchange between air passing through each exhaust passage and air passing through each supply passage.

Preferably, driving of the exhaust fan driving device and the supply fan driving device may be controlled while continuously varying a difference between the supply amount of air introduced to each specific indoor space and the exhaust amount of air discharged to the outside according to the radon concentration value of each specific indoor space.

Preferably, the ventilation control device may operate in a night ventilation mode at a preset evening time and control driving of the exhaust fan driving device and the air supply fan driving device to increase a supply amount of air introduced to each specific indoor space and an exhaust amount of air discharged to the outside by a preset air supply amount and exhaust amount so as to reduce indoor radon and create a comfortable indoor environment.

Preferably, the ventilation control device may operate in a sleep ventilation mode at a preset sleeping time, control driving of the air supply fan driving device to maintain a supply amount of air introduced to each specific indoor space at a preset minimum supply amount, and stop the driving of the exhaust fan driving device to reduce a noise, thereby minimizing a sleep disturbance such that the amount of air discharged to the outside is zero.

Preferably, a display device may be further included to display radon concentration information data of the specific indoor spaces measured from the indoor radon measuring devices on a display screen, wherein the ventilation control device may receive radon concentration information data of the specific indoor space measured from the indoor radon measuring devices in real time, and control an operation of the display device such that radon concentration values for each specific indoor space are displayed on the display screen by hour/date/day/week/month/quarter/year, based on the radon concentration information data.

Preferably, a storage device may be further included to store radon concentration information data of the specific indoor spaces measured from the indoor radon measuring devices, wherein the ventilation control device may receive radon concentration information data of each specific indoor space measured from the indoor radon measuring devices in real time, and control an operation of the storage device such that radon concentration values for each specific indoor space are established in a database by hour/date/day/week/month/quarter/year and stored in the storage device, based on the radon concentration information data.

Preferably, a communication device may be further included to transmit radon concentration information data of each specific indoor space measured from each indoor radon measuring device to the outside through wired or wireless communication, wherein the ventilation control device may receive radon concentration information data of the specific indoor spaces measured from the indoor radon measuring devices in real time, and control an operation of the communication device such that radon concentration values for the specific indoor space are transmitted by wire or wirelessly to an external user terminal or server, based on the radon concentration information data.

Preferably, the user terminal may control to display the transmitted radon concentration values for the specific indoor spaces on a display screen by hour/date/day/week/month/quarter/year through a pre-installed specific application service.

Preferably, when the radon concentration value for each specific indoor space transmitted through a pre-installed specific application service exceeds a preset risk radon concentration reference value, the user terminal may control to generate and display a preset radon risk warning message on the display screen according to the radon concentration value for each specific indoor space.

Preferably, it may further include: an air purification filter device installed at a front end or rear end of the exhaust fan or the air supply fan provided in the blowing device, or installed at a front end or rear end of each exhaust damper or air supply damper provided in the air distribution device, and having at least one filter cartridge for purifying air introduced to each specific indoor space or air discharged to the outside; and a filter pressure measuring device installed on one side of the air purification filter device, and having at least one pressure sensor for measuring a filter pressure value of each filter cartridge provided in the air purification filter device by using a pressure of the air introduced to the indoor space or the air discharged to the outside.

Preferably, the ventilation control device may receive the filter pressure value in real time from the filter pressure measuring device, generate filter contamination level information data classified in advance by grade according to the real-time filter pressure value when the real-time filter pressure value reaches within a preset replacement pressure value range based on the filter pressure value, and control to transmit the generated filter contamination level information data to an external user terminal or server by wire or wirelessly through a separate communication device.

Preferably, the user terminal may receive the filter contamination level information data classified in advance by grade according to the real-time filter pressure value from the ventilation control device through the pre-installed specific application service, based thereon, and control to display a filter contamination level value for each filter cartridge provided in the air purification filter device on the display screen by hour/date/day/week/month/quarter/year.

Preferably, the ventilation control device may calculate a real-time air flow rate value based on real-time rotation speed information of the exhaust fan and the air supply fan provided in the blowing device, and real-time opening degree information of each of the exhaust dampers and each of the supply air dampers provided in the air distribution device, may calculate an accumulated air flow rate value by accumulating the calculated air flow rate value in real time, may predict a filter pressure value for a change rate of the accumulated air flow value based on a filter pressure value at an accumulated air flow rate value at a predetermined time, and, when the predicted filter pressure value reaches within a preset replacement pressure value range, may control to transmit the predicted filter contamination level information data classified in advance by grade according to the predicted filter pressure value to the external user terminal or server through the separate communication device by wire or wirelessly.

Preferably, the user terminal may receive the filter contamination level information data classified in advance by grade according to the predicted filter pressure value from the ventilation control device through the pre-installed specific application service, based thereon, and control to display a filter contamination level value for each filter cartridge provided in the air purification filter device on the display screen by hour/date/day/week/month/quarter/year.

Preferably, the ventilation control device may calculate a real-time air flow rate value based on real-time rotation speed information of the exhaust fan and the air supply fan provided in the blowing device, and real-time opening degree information of each of the exhaust dampers and each of the supply air dampers provided in the air distribution device, may calculate an accumulated air flow rate value by accumulating the calculated air flow rate value in real time, may predict a filter pressure value for a change rate of the accumulated air flow value based on a filter pressure value at an accumulated air flow rate value at a predetermined time, may generate filter contamination level information data classified in advance by grade according to the predicted filter pressure value when the predicted filter pressure value reaches within a preset replacement pressure value range, may select one having a higher value between the generated filter contamination level value and the predicted filter contamination level value as a control criterion, may execute a weighting mode when the high value between the generated filter contamination level value and the predicted filter contamination level value exceeds a preset reference value, and may control to operate faster than preset operating speeds of the exhaust fan and the air supply fan to compensate for a pressure due to a filter clogging when the radon concentration value for each specific indoor space during execution of the weighting mode is greater than or equal to a preset risk radon concentration reference value.

Preferably, when the radon concentration value for each specific indoor space during execution of the weighting mode is smaller than or equal to the preset risk radon concentration reference value, the ventilation control device may control to operate slower than preset operating speeds of the exhaust fan and the air supply fan to increase a filter lifespan.

### Advantageous Effects

According to the ventilation system for reducing indoor radon concentration of the present invention as described above, a plurality of indoor radon measuring devices installed in a plurality of specific indoor spaces provided inside the building is used, so as to radon concentration information in each specific indoor space can be monitored in real time, radon concentration in indoor air can be effectively reduced, and ventilation equipment installed in the building can be effectively controlled.

### DESCRIPTION OF DRAWINGS

FIG. 1 is an overall block diagram for explaining a ventilation system for reducing an indoor radon concentration according to one embodiment of the present invention.

FIG. 2 is a block diagram for explaining in detail an indoor radon measuring device applied to one embodiment of the present invention.

FIG. 3 is a perspective view schematically explaining a blowing device and an air distribution device applied to one embodiment of the present invention.

### BEST MODE

### Mode for Invention

The above-described objects, features and advantages will be described in detail later with reference to the accompanying drawings, and accordingly, a person having ordinary skill in the art may easily implement the technical idea of the present invention. In the following description of the embodiments of the present invention, the detailed description of the related known technology incorporated herein will be omitted when it possibly makes the subject matter of the present invention unclear unnecessarily.

The terms including an ordinal number such as first and second may be used to describe various elements, however, the elements are not limited by the terms. The terms are used only for the purpose of distinguishing one element from another element. For example, the first element may be referred to as the second element without departing from the scope of the present invention, and similarly, the second element may also be referred to as the first element. The terms used herein are merely for the purpose of illustrating a particular embodiment, and it is not intended to limit the present invention. The singular expression includes a plural expression unless the context clearly means otherwise.

General term which is widely used recently has been selected in the present invention in consideration of the function according to the present invention as possible, however, the term may vary depending on the intention of those skilled in the art, judicial cases, the advent of new technology, or the like. In addition, in certain cases, the term may be arbitrarily selected by the applicant, and in this case, the meaning thereof will be described in detail in the relevant description of the invention. Therefore, the term used in the present invention should be defined based on the meaning of the term and contents throughout the present invention, not simply on the name of the term.

Throughout the specification herein, when one part “includes” some elements, it does not exclude other elements, but may further include the other elements, unless particularly stated otherwise. In addition, the term “ . . . unit”, “ . . . module”, or an equivalent thereof means a unit for processing at least one function or operation, which may be implemented in hardware or software, or in a combination of hardware and software.

Hereinafter, the embodiments of the present invention will be described in detail with reference to the accompanying drawings. However, the embodiments of the present invention illustrated as follows may be modified in various different forms, and the scope of the present invention is not limited to the embodiments described in detail as follows. The embodiments of the present invention are provided to more completely describe the invention to a person having ordinary skill in the art.

Combinations of each block of the attached block diagram and each step of the flowchart may be performed by computer program instructions (execution engine), and the computer program instructions may be mounted on a processor of a general purpose computer, a special purpose computer or other programmable data processing equipment. Accordingly, the instructions, which are performed by the processor of the computer or other programmable data processing equipment, may generate means for performing functions described in each block of the block diagram or each step of the flowchart. Since the computer program instructions may also be stored in a computer-usable or computer-readable memory which may be directed to a computer or other programmable data processing equipment to implement the functions in particular ways, the instructions stored in the computer-usable or computer-readable memory may produce an article of manufacture containing instruction means for performing the functions described in each block of the block diagram or each step of the flow chart.

In addition, since the computer program instructions may also be mounted on the computer or other programmable data processing equipment, instructions for performing the computer or other programmable data processing equipment by creating a computer-executable process by performing a series of operational steps on the computer or other programmable data processing equipment may also provide steps for executing functions described in each block of the block diagram and each step in the flowchart.

In addition, each block or each step may represent a module, a segment, or a part of code including one or more executable instructions for executing specified logical functions, and it should be noted that the functions mentioned in the blocks or steps may occur out of order in some alternative embodiments. For example, two blocks or steps shown in succession may be performed substantially at the same time, and the blocks or steps may be performed in the reverse sequence of the corresponding functions as necessary.

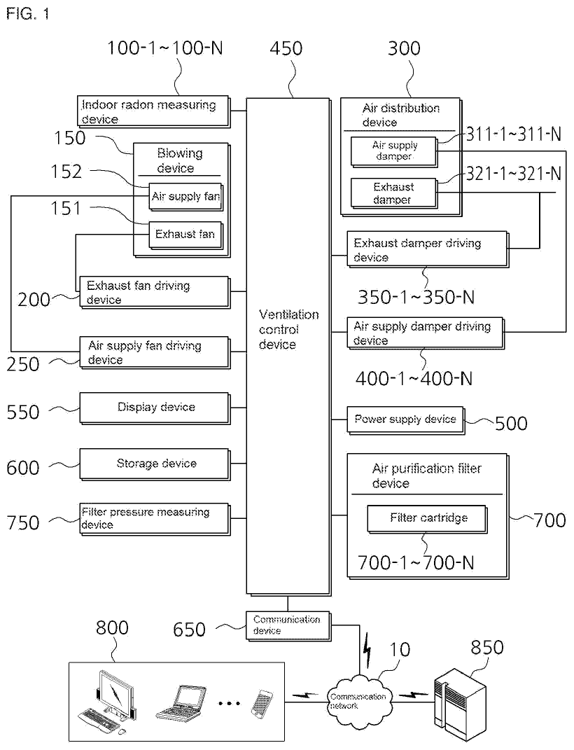

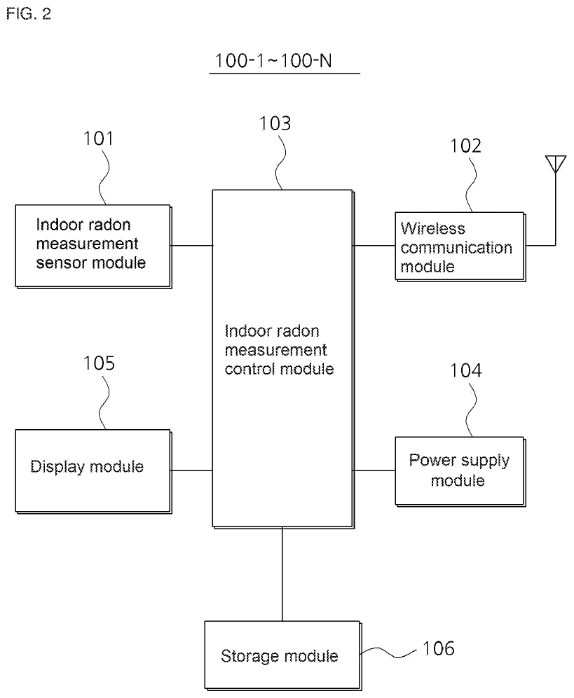

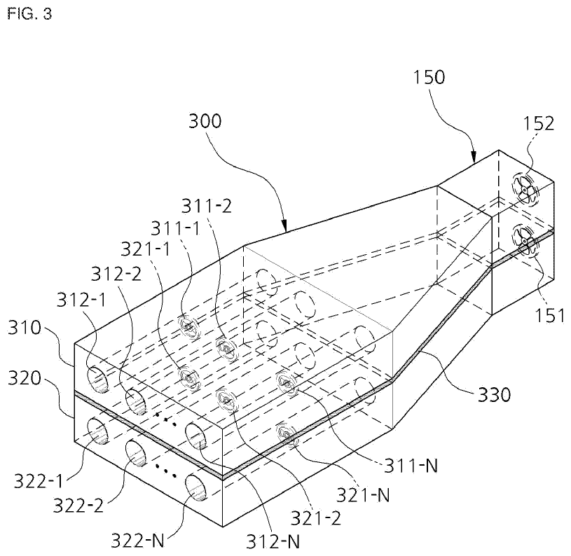

FIG. 1 is an overall block diagram for explaining a ventilation system for reducing an indoor radon concentration according to one embodiment of the present invention. FIG. 2 is a block diagram for explaining in detail an indoor radon measuring device applied to one embodiment of the present invention. FIG. 3 is a perspective view schematically explaining a blowing device and an air distribution device applied to one embodiment of the present invention.

Referring to FIGS. 1 to 3, the ventilation system for reducing indoor radon concentration according to one embodiment of the present invention mainly includes a plurality of indoor radon measuring devices 100-1 to 100-N, a blowing device 150, an exhaust fan driving device 200, an air supply fan driving device 250, an air distribution device 300, a plurality of exhaust damper driving devices 350-1 to 350-N, a plurality of air supply damper driving devices 400-1 to 400-N, a ventilation control device 450, and a power supply device 500. In addition, the ventilation system for reducing indoor radon concentration according to one embodiment of the present invention may further include a display device 550, a storage device 600, a communication device 650, an air purification filter device 700, a filter pressure measuring device 750, a user terminal 800, a server 850, and the like. Meanwhile, since the elements shown in FIGS. 1 to 3 are not essential, the ventilation system for reducing indoor radon concentration according to one embodiment of the present invention may have elements more or fewer than the above-shown elements.

Hereinafter, elements of the ventilation system for reducing indoor radon concentration according to one embodiment of the present invention will be described in detail as follows.

Each of the indoor radon measuring devices 100-1 to 100-N are installed in a plurality of specific indoor spaces (for example, room, office, classroom, and the like) provided inside a structure (for example, villa, apartment, building, school, or the like), and perform a function of measuring radon concentration information data of the specific indoor spaces, respectively.

As shown in FIG. 2, each of the indoor radon measuring devices 100-1 to 100-N mainly includes an indoor radon measurement sensor module 101, a wireless communication module 102, an indoor radon measurement control module 103, and a power supply module 104. In addition, each of the indoor radon measuring devices 100-1 to 100-N applied to one embodiment of the present invention may further include a display module 105, a storage module 106, and the like. Meanwhile, since the elements shown in FIG. 2 are not essential, each of the indoor radon measuring devices 100-1 to 100-N applied to one embodiment of the present invention may have elements more or fewer than the above-shown elements.

Hereinafter, elements of each indoor radon measuring device 100-1 to 100-N applied to one embodiment of the present invention will be described in detail as follows.

The indoor radon measurement sensor module 101 is installed in a specific indoor space, and performs a function of measuring radon concentration data in the specific indoor space.

The indoor radon measurement sensor module 101 may preferably include, for example, at least one radon measurement sensor using a pulsed ionization chamber scheme, but it is not limited thereto, and for example, a radon measurement sensor, to which a surface barrier type detector, a high purity semiconductor detector (pure Ge), a scintillation detector, a solid state junction counter, or the like is applied, may also be included as a device for detecting alpha particles.

In other words, the radon measurement sensor using the pulsed ionization chamber scheme has a structure in which a probe-shape electrode is installed in a center inside a cylindrical box formed of metal and a bias voltage is applied between the metal cylinder and the inner probe so as to form an electric field.

When alpha decay occurs inside the ionization chamber and alpha particles are released, the alpha particles are annihilated due to collision with air, but ion charges are generated. Accordingly, alpha particles may be detected by absorbing the ion charges through the central probe and amplifying the signal. Since the sensor itself is formed of a metal cylinder and a probe, it is very inexpensive, has a good durability, and has an improved air permeability due to irrelevance of light.

Referring to the surface barrier type detector, a depletion layer such as a p-n junction is formed on a surface of a semiconductor due to a surface level, an oxide film or the like, and thus the vicinity of the surface becomes an obstacle to a charge transfer. Practically, gold is deposited on a surface of an n-type Si by about 100 μm/cm² to serve as one electrode, and radiation is incident onto a rear surface. Since the depletion layer may have various thicknesses, such as about 50 μm to about 500 μm, and the energy loss at the surface is small, the surface barrier type detector is mainly used to detect charged particles generated as alpha radiation and has an excellent energy resolution.

The high purity semiconductor detector is also generally referred to as a pure Ge detector. As a high purity Ge crystal having a very small impurity concentration or defect, an electrical resistance is very high at a low temperature, and a high bias voltage may also be applied. Compared to Ge (Li), the high purity Ge is convenient for maintenance because the high purity Ge may be stored at room temperature and cooled by liquid nitrogen only when a measurement is required. In addition, since energy resolution is also comparable to Ge(Li), the high purity Ge is being put into practical use.

Referring to the scintillation detector, it has been known for a long time that charged particles emit light upon hitting a substance, and light emission by alpha radiation of zinc sulfide (ZnS) or Nal coating is particularly strong and may be detected and counted in a darkroom by using a magnifying glass.

The light emission is called scintillation (flash), and a substance exhibiting the above phenomenon is called a scintillator. In addition, a combination of a photomultiplier tube with a scintillator is called a scintillation detector, and particularly, a scheme used for counting as a pulse output is called a scintillation counter.

Meanwhile, when an output read as a direct current is mainly used for dosimetry and a scintillator is used, it is called a scintillation dosimeter. Any state of solid, liquid, or gas is used in the scintillator. When a liquid is used, it is called a liquid scintillation counter.

The solid junction counter, as a solid reverse bias p-n junction semiconductor, is a counter configured to collect ionic charges from alpha particles passing through a depletion layer, and may be manufactured in a small size and in a mobile type.

The wireless communication module 102 performs a function of wirelessly transmitting the radon concentration information data in each specific indoor space measured from the indoor radon measurement sensor module 101.

The wireless communication module 102 may be implemented using, for example, a short-range wireless communication scheme such as wireless broadband Internet (Wibro), WiGig, world interoperability for microwave access (Wimax), high speed downlink packet access (HSDPA), wireless personal area network (WPAN), cellular-based 3G network, LTE network, WiFi, Beacon, ZigBee, Bluetooth, ultra-wideband (UWB), radio frequency identification (RFID), and infrared rays (IR) communication.

The indoor radon measurement control module 103 is configured to control overall operations of each indoor radon measuring device 100-1 to 100-N, in which various functions may be performed for each indoor radon measuring device 100-1 to 100-N, and various software programs and/or instruction sets stored in the storage module 106 may be executed or performed to process data. In other words, the indoor radon measurement control module 103 may process various signals based on information stored in the storage module 106.

In addition, the indoor radon measurement control module 103 may transmit/receive various signals to/from the wireless communication module 102. In other words, the indoor radon measurement control module 103 may perform various operations based on the various signals transmitted to and received from the wireless communication module 102.

In other words, the indoor radon measurement control module 103 controls operations of the indoor radon measurement sensor module 101, the wireless communication module 102, the display module 105, the storage module 106, and the like, and particularly performs a function of controlling operations of the wireless communication module 102, such that the radon concentration information data of each specific indoor space measured from the indoor radon measurement sensor module 101 is received in real time and transmitted wirelessly to the ventilation control device 450.

In addition, the indoor radon measurement control module 103 may perform a function of calculating an amount of fine dust in each specific indoor space through the following [Equation 1] according to the presence or absence of a filter (not shown) for separating radon progeny when the indoor radon measurement sensor module 101 measures radon.

Total radon amount=Pure radon amount+Radon progeny attached to fine dust [Equation 1]

The pure radon amount refers to an amount of radon from which radon progeny, which is a substance generated when radon decays and measured while being attached to fine dust, is removed by using a filter for separating radon progeny when radon is measured.

In other words, the radon meter using the ionization chamber scheme measures alpha rays emitted from radon gas in the indoor space. The total radon amount is required to be distinguished from the pure radon amount when radon is measured. The total radon amount is obtained by calculating and including both of alpha rays emitted from radon gas and alpha rays emitted from the radon progeny generated after the radon gas decays.

Basically, since the radon meter using the ionization chamber scheme measures all alpha rays, the pure radon amount is measured after removing radon progeny, which is a substance generated when radon decays and measured while being attached to fine dust, by using a HEPA filter to separate the radon progeny during measuring radon.

The amount of radon progeny may be determined by comparing a variable-type or filter-equipped radon meter with a filterless radon meter by using the characteristics of radon.

The amount of fine dust in the indoor space may be measured through the above [Equation 1]. Meanwhile, according to the conventional method of measuring fine dust, a light scattering method identifies an amount and size of dust to separate a total amount of dust and an amount of fine dust by type, but there is a practical difficulty as a monitoring sensor for a long time due to the difficulty in durability and maintenance of an optical sensor.

In order to solve the above problem, it is difficult to distinguish the type of dust when a radon sensor is used to predict indoor dust, however the radon sensor may be usable as a stable and durable fine dust meter and it is very effective because radon measurement and fine dust prediction may be simultaneously performed by using the radon measurement sensor.

In addition, the power supply module 104 performs a function of supplying power necessary for each module, that is, the indoor radon measurement sensor module 101, the wireless communication module 102, the indoor radon measurement control module 103, the display module 105, the storage module 106, and the like, and may be preferably implemented by converting a commercial alternating current (AC) power (such as AC 220V) into a direct current (DC) and/or alternating current (AC) power to continuously supply the power. However, it is not limited thereto, and may also be implemented by solar heat power supply or a conventional portable battery.

In addition, the display module 105 performs a function of displaying the radon concentration information data of each specific indoor space measured from the indoor radon measurement sensor module 101 under the control of the indoor radon measurement control module 103 on a display screen such that a user may monitor in real time.

The display module 105 may include, for example, a liquid crystal display (LCD), light emitting diode (LED), thin film transistor-liquid crystal display (TFT LCD), organic light emitting diode (OLED), flexible display, plasma display panel (PDP), Alternate lighting of surfaces (ALiS), digital light processing (DLP), liquid crystal on silicon (LCoS), surface-conduction electron-emitter display (SED), field emission display(FED), laser TV (quantum dot laser, liquid crystal laser), ferroelectric liquid crystal display (FLD), interferometric modulator display (iMoD), thick-film dielectric electroluminescent (TDEL), quantum dot display (QD-LED), telescopic pixel display (TPD), organic light emitting transistor (OLET), and laser-powered phosphor display (LPD), but it is not limited thereto, and may include anything that can display numbers or characters, etc.

Further, the storage module 106 may include a program memory and a data memory. The program memory stores programs for controlling general operations of each indoor radon measuring device 100-1 to 100-N. The program memory may store a program for measuring radon concentration information data of each specific indoor space through each indoor radon measuring device 100-1 to 100-N.

In addition, the program memory may store a program for driving the indoor radon measurement sensor module 101, the wireless communication module 102, the display module 105, the storage module 106, and the like under the control of the indoor radon measurement control module 103. The data memory stores data generated during execution of the programs in each indoor radon measuring device 100-1 to 100-N. The data memory may store, for example, module information, channel information, frequency information, or network information. In addition, the data memory of the storage module 106 may store unique device identification information and the like of each indoor radon measuring device 100-1 to 100-N.

In addition, the storage module 106 may store radon concentration information data of each specific indoor space measured from the indoor radon measurement sensor module 101 under the control of the indoor radon measurement control module 103.

In other words, the storage module 106 may store and maintain at least one program code executed through the indoor radon measurement control module 103, and at least one data set in which the program code is used.

The storage module 106 may include, for example, at least one type of readable storage media among a flash memory type memory, a hard disk type memory, a multimedia card micro type memory, a card type memory (such as SD or XD memory), random access memory (RAM), a static random access memory (SRAM), a read-only memory (ROM), an electrically erasable programmable read-only memory (EEPROM), a programmable read-only memory (PROM), a magnetic memory, a magnetic disc, and a compact disc.

The blowing device 150 is installed on an outer wall of a building and/or in a specific place outdoors, and provided with an exhaust fan 151 for exhausting air in each specific indoor space and an air supply fan 152 for supplying outdoor air.

The exhaust fan driving device 200 is electrically connected to the ventilation control device 450, and performs a function of operating the exhaust fan 151 provided in the blowing device 150 and driving an air flow rate to be variable according to the control of the ventilation control device 450.

The air supply fan driving device 250 is electrically connected to the ventilation control device 450, and performs a function of operating the air supply fan 152 provided in the blowing device 150 and driving an air flow rate to be variable according to the control of the ventilation control device 450.

The air distribution device 300 is divided into an upper chamber 310 and a lower chamber 320. The upper chamber 310 includes a plurality of air supply passages 312-1 to 312-N connected to one end of the air supply fan 152 and accommodating a plurality of air supply dampers 311-1 to 311-N to supply and distribute outdoor air individually to each specific indoor space, and the lower chamber 320 includes a plurality of exhaust passages 322-1 to 322-N connected to one end of the exhaust fan 151 and accommodating a plurality of exhaust dampers 321-1 to 321-N to individually exhaust the air in each specific indoor space.

Meanwhile, at least one heat exchange member 330 may be preferably provided between the upper chamber 310 and the lower chamber 320 provided in the air distribution device 300 to allow heat exchange between the air passing through each exhaust passage 322-1 to 322-N and the air passing through each supply passage 312-1 to 312-N.

The heat exchange member 330 has a plate shape or a box shape having a predetermined size to increase heat exchange efficiency, in which the size and shape may be variously modified within a range that can sufficiently secure a heat transfer area.

Each of the exhaust damper driving devices 350-1 to 350-N performs a function of driving each of the exhaust dampers 321-1 to 321-N to control a flow rate of the air discharged through the exhaust fan 151 from an exhaust port (not shown) in each specific indoor space according to the degree of opening of each exhaust passage 322-1 to 322-N from full opening to full closing of each exhaust passage 322-1 to 322-N stepwise according to a specific ventilation control signal transmitted from the ventilation control device 450.

Each of the air supply damper driving devices 400-1 to 400-N performs a function of driving each of the air supply dampers 311-1 to 311-N to control a flow rate of the air introduced from the air supply fan 152 to an outdoor air supply port (not shown) according to the degree of opening of each air supply passage 312-1 to 312-N from full opening to full closing of each air supply passage 312-1 to 312-N stepwise according to a specific ventilation control signal transmitted from the ventilation control device 450.

In general, each of the exhaust damper driving device 350-1 to 350-N and the air supply damper driving device 400-1 to 400-N may include at least one drive motor unit for rotating at least one opening/closing plate (not shown) provided in each of the exhaust damper 321-1 to 321-N and the air supply damper 311-1 to 311-N, and a controller for controlling the driving of the drive motor unit. A detailed description as a generally well known technology will be omitted in the present invention.

The ventilation control device 450 is configured to control overall operations of the ventilation system for reducing indoor radon concentration according to one embodiment of the present invention. In particular, the ventilation control device 450 receives radon concentration information data of each specific indoor space measured from each of the indoor radon measuring devices 100-1 to 100-N in real time, when at least one of radon concentration values of the specific indoor space is greater than a preset risk radon concentration reference value, based on the radon concentration information data, operates in a primary overall ventilation mode for suppressing radon flowing into each specific indoor space through a positive pressure principle according to the radon concentration value of the corresponding specific indoor space, and control driving of the exhaust fan driving device 200 and the air supply fan driving device 250 such that a supply amount of air introduced to each specific indoor space is adjusted to be higher than an exhaust amount of air discharged to the outside.

In other words, the ventilation control device 450 performs a function of controlling the driving of the exhaust fan driving device 200 and the air supply fan driving device 250, such that the exhaust fan 151 and the air supply fan 152 operate at a preset air flow rate value corresponding to the radon concentration value of the specific indoor space.

In addition, the ventilation control device 450 allows the supply amount of air introduced to each specific indoor space higher than the exhaust amount of air discharged outdoors, so that a slight positive pressure is applied to the indoor to inhibit radon from entering the indoor space when the supply amount of air introduced to the indoor space is greater than the exhaust amount.

In addition, after the operation of the primary overall ventilation mode, the ventilation control device 450 receives radon concentration information data of each specific indoor space measured from each of the indoor radon measuring devices 100-1 to 100-N in real time analyzes radon concentration changing values for each specific indoor space based on the radon concentration information data, operates in a secondary individual ventilation mode for suppressing radon introduced to each specific indoor space according to radon concentration change values for each specific indoor space, generates a specific ventilation control signal for individually controlling driving of the exhaust damper driving device 350-1 to 350-N and the air supply damper driving device 400-1 to 400-N to control a flow rate of air introduced to each specific indoor space and a flow rate of air discharged to the outside, and performs a function of transmitting the specific ventilation control signal to the exhaust damper driving device 350-1 to 350-N and the air supply damper driving device 400-1 to 400-N.

In other words, the ventilation control device 450 performs a function of individually controlling driving of the exhaust damper driving device 350-1 to 350-N and the air supply damper driving device 400-1 to 400-N, such that each exhaust damper 321-1 to 321-N and each air supply damper 311-1 to 311-N are individually operated with a preset air flow rate value corresponding to radon concentration change values for each specific indoor space.

Further, in the secondary individual ventilation mode, the ventilation control device 450 may perform a function of individually controlling driving of the exhaust damper driving device 350-1 to 350-N and the air supply damper driving device 400-1 to 400-N, such that a flow rate of air introduced to each specific indoor space is adjusted to be higher than a flow rate of air discharged to the outside, so as to suppress radon introduced to each specific indoor space through a positive pressure principle according to a radon concentration change value for each specific indoor space.

Further, when a first specific indoor space corresponding to a change value of increasing radon concentration among change values of radon concentration in each specific indoor space in the secondary individual ventilation mode, the ventilation control device 450 may perform a function of generating a specific ventilation control signal for controlling driving of a first exhaust damper driving device 350-1 and a first air supply damper driving device 400-1 corresponding to the first specific indoor space, so as to increase a flow rate of air introduced to the first specific indoor space and decrease a flow rate of air discharged to the outside according to the change value of increasing radon concentration.

In addition, when a second specific indoor space corresponding to a change value of decreasing radon concentration among the change values of radon concentration in each specific indoor space, the ventilation control device 450 may perform a function of generating a specific ventilation control signal for controlling driving of a second exhaust damper driving device 350-2 and a second air supply damper driving device 400-2 corresponding to the second specific indoor space, so as to decrease a flow rate of air introduced to the second specific indoor space and increase a flow rate of air discharged to the outside according to the change value of decreasing radon concentration.

In addition, after the primary overall ventilation mode and/or the secondary individual ventilation mode is operated, the ventilation control device 450 may receive radon concentration information data of each specific indoor space measured from each of the indoor radon measuring devices 100-1 to 100-N in real time, and control driving of the exhaust fan driving device 200 and the air supply fan driving device 250 so as to decrease a current supply amount of air introduced to each specific indoor space and increase a current exhaust amount of air discharged to the outdoors when the radon concentration value of the specific indoor space is smaller than the preset risk radon concentration reference value, based on the radon concentration information data.

In addition, when the radon concentration value of the specific indoor space is smaller than the preset risk radon concentration reference value, the ventilation control device 450 may decrease the current supply amount of air introduced to each specific indoor space and increase the current exhaust amount of air discharged to the outdoors, and perform a function of controlling driving of the exhaust fan driving device 200 and the air supply fan driving device 250, such that a supply amount of air introduced to each specific indoor space is adjusted to be higher than an exhaust amount of air discharged to the outside so as to suppress radon introduced to each specific indoor space through the positive pressure principle.

In addition, after calculating a time required for at least one of radon concentration values of the specific indoor space to the preset risk radon concentration reference value, and when the calculated required time reaches within a preset reference time range, the ventilation control device 450 may operate in the primary overall ventilation mode for suppressing radon introduced to each specific indoor space through the positive pressure principle according to the calculated required time, and control driving of the exhaust fan driving device 200 and the air supply fan driving device 250 such that a supply amount of air introduced to each specific indoor space is adjusted to be higher than an exhaust amount of air discharged to the outside.

In addition, the ventilation control device 450 may perform a function of controlling driving of the exhaust fan driving device 200 and the air supply fan driving device 250, while continuously varying a difference between the supply amount of air introduced to each specific indoor space and the exhaust amount of air discharged to the outside according to the radon concentration value of each specific indoor space.

In addition, the ventilation control device 450 may perform a function of controlling driving of the exhaust fan driving device 200 and the air supply fan driving device 250, in which the ventilation control device 450 operates in a night ventilation mode at a preset evening time, and increases a supply amount of air introduced to each specific indoor space and an exhaust amount of air discharged to the outside by a preset air supply amount and exhaust amount so as to reduce indoor radon and create a comfortable indoor environment.

In addition, the ventilation control device 450 may operate in a sleep ventilation mode at a preset sleeping time, control driving of the air supply fan driving device 250 to maintain a supply amount of air introduced to each specific indoor space at a preset minimum supply amount, and stop the driving of the exhaust fan driving device 200 to reduce a noise, thereby minimizing a sleep disturbance so that the amount of air discharged to the outside is a zero state.

In addition, the ventilation control device 450 is configured to receive radon concentration information data of each specific indoor space measured from each of the indoor radon measuring devices 100-1 to 100-N in real time, based thereon, such that radon concentration values for each specific indoor space are displayed on the display screen by hour and/or date and/or day and/or week and/or month and/or quarter and/or year may perform a function . . . control an operation of the display device 550

In addition, the ventilation control device 450 is configured to receive radon concentration information data of each specific indoor space measured from each of the indoor radon measuring devices 100-1 to 100-N in real time, based thereon, such that radon concentration values for each specific indoor space are established into a database by hour and/or date and/or day and/or week and/or month and/or quarter and/or year and stored in the storage device 600 may perform a function . . . control an operation of the storage device 600.

In addition, the ventilation control device 450 may receive radon concentration information data of each specific indoor space measured from each of the indoor radon measuring devices 100-1 to 100-N in real time, and control an operation of the communication device 650 based on the radon concentration information data, such that radon concentration values for each specific indoor space are transmitted by wire or wirelessly to an external user terminal 800 and/or server 850 through a communication network 10.

The communication network 10 is a communication network that is a high-speed backbone network of a large communication network capable of large-capacity and long-distance voice and data services, and may be a next-generation wireless communication network including Wi-Fi, WiGig, wireless broadband Internet (Wibro), world interoperability for microwave access (Wimax), and the like for providing Internet or high-speed multimedia services.

The Internet refers to a global open computer network structure that provides a TCP/IP protocol and various services existing at an upper layer thereof, such as hyper text transfer protocol (HTTP), Telnet, file transfer protocol (FTP), domain name system (DNS), simple mail transfer protocol (SMTP), simple network management protocol (SNMP), network file service (NFS), and network information service (NIS), and provides an environment that enables the ventilation control device 450 to be connected to the user terminal 800 and/or the server 850. Meanwhile, the Internet may be wired or wireless Internet, and may be a core network integrated with a wired public network, a wireless mobile communication network, or a portable Internet.

In the case of a mobile communication network, the communication network 10 may be a synchronous mobile communication network or an asynchronous mobile communication network. As an embodiment of the asynchronous mobile communication network, a wideband code division multiple access (WCDMA) type communication network may be used. In this case, although not shown in the drawings, the mobile communication network may include, for example, a radio network controller (RNC) and the like. Meanwhile, although the WCDMA network has been taken as an example, it may be a cellular-based 3G network, an LTE network, or other IP-based networks. The communication network 10 serves to mutually transmit signals and data of the ventilation control device 450 and the user terminal 800 and/or the server 850.

In addition, the ventilation control device 450 may receive the filter pressure value in real time from the filter pressure measuring device 750, generate filter contamination level information data classified in advance by grade according to the real-time filter pressure value, based on the filter pressure value, when the real-time filter pressure value reaches within a preset replacement pressure value range, and control to transmit the generated filter contamination level information data to the external user terminal 800 and/or the server 850 by wire or wirelessly through the communication device 650 and the communication network 10.

In addition, the ventilation control device 450 may calculate real-time rotation speed information of the exhaust fan 151 and the air supply fan 152 provided in the blowing device 150, and a real-time air flow rate value based on real-time opening degree information of each of the exhaust dampers 321-1 to 321-N and each of the supply air dampers 311-1 to 311-N provided in the air distribution device 300, calculate an accumulated air flow rate value by accumulating the calculated air flow rate value in real time, predict a filter pressure value for a change rate of the accumulated air flow value based on a filter pressure value at an accumulated air flow rate value at a predetermined time, and when the predicted filter pressure value reaches within a preset replacement pressure value range, control to transmit the predicted filter contamination level information data classified in advance by grade according to the predicted filter pressure value by wire and/or wirelessly to the external user terminal 800 and/or the server 850 through the communication device 650 and the communication network 10.

In addition, the ventilation control device 450 may select one having a higher value between the generated filter contamination level value and the predicted filter contamination level value as a control criterion, execute a weighting mode when the high value between the generated filter contamination level value and the predicted filter contamination level value exceeds a preset reference value, and control to operate faster than preset operating speeds of the exhaust fan and the air supply fan to compensate for a pressure due to a filter clogging when the radon concentration value for each specific indoor space during execution of the weighting mode is greater than or equal to a preset risk radon concentration reference value.

In addition, when the radon concentration value for each specific indoor space during execution of the weighting mode is smaller than or equal to the preset risk radon concentration reference value, the ventilation control device 450 may control to operate slower than preset operating speeds of the exhaust fan and the air supply fan to increase a filter lifespan.

In addition, the power supply device 500 performs a function of supplying power required for various devices, that is, the indoor radon measuring devices 100-1 to 100-N, the blowing device 150, the exhaust fan driving device 200, the air supply fan driving device 250, the air distribution device 300, the exhaust damper driving devices 350-1 to 350-N, the air supply damper driving devices 400-1 to 400-N, the ventilation control device 450, the display device 550, the storage device 600, the communication device 650, the air purification filter device 700, the filter pressure measuring device 750, and the like, and may be preferably implemented by converting a commercial alternating current (AC) power (such as AC 220V) into a direct current (DC) and/or alternating current (AC) power to continuously supply the power. However, it is not limited thereto, and may be implemented by a geothermal heat or a general battery.

In addition, the display device 550 is electrically connected to the ventilation control device 450, and may perform a function of displaying the radon concentration information data of each specific indoor space measured by each indoor radon measuring device 100-1 to 100-N on the display screen according to the control of the ventilation control device 450.

The display device 550 may include, for example, a liquid crystal display (LCD), light emitting diode (LED), thin film transistor-liquid crystal display (TFT LCD), organic light emitting diode (OLED), flexible display, plasma display panel (PDP), Alternate lighting of surfaces (ALiS), digital light processing (DLP), liquid crystal on silicon (LCoS), surface-conduction electron-emitter display (SED), field emission display(FED), laser TV (quantum dot laser, liquid crystal laser), ferroelectric liquid crystal display (FLD), interferometric modulator display (iMoD), thick-film dielectric electroluminescent (TDEL), quantum dot display (QD-LED), telescopic pixel display (TPD), organic light emitting transistor (OLET), and laser-powered phosphor display (LPD), but it is not limited thereto, and may include anything that can display numbers or characters, etc.

In addition, the storage device 600 is electrically connected to the ventilation control device 450, and may perform a function of storing the radon concentration information data of each specific indoor space measured by each indoor radon measuring device 100-1 to 100-N on the display screen according to the control of the ventilation control device 450.

The storage device 600 may include, for example, at least one type of readable storage media among a flash memory type memory, a hard disk type memory, a multimedia card micro type memory, a card type memory (such as SD or XD memory), random access memory (RAM), a static random access memory (SRAM), a read-only memory (ROM), an electrically erasable programmable read-only memory (EEPROM), a programmable read-only memory (PROM), a magnetic memory, a magnetic disc, and a compact disc.

In addition, the communication device 650 is electrically connected to the ventilation control device 450, and may perform a function of transmitting the radon concentration information data of each specific indoor space measured by each indoor radon measuring device 100-1 to 100-N by wire and/or wirelessly to the outside according to the control of the ventilation control device 450.

The communication device 650 may be preferably implemented to communicate by wire and/or wirelessly through the communication network 10, but it is not limited thereto, and may be implemented using, for example, a short-range wireless communication scheme such as Beacon, ZigBee, Bluetooth, ultra-wideband (UWB), radio frequency identification (RFID), and infrared rays (IR) communication.

In addition, the air purification filter device 700 is installed at a front end and/or a rear end of the exhaust fan 151 and/or the air supply fan 152 provided in the blowing device 150, or installed at a front end and/or a rear end of each exhaust damper 321-1 to 321-N and/or air supply damper 311-1 to 311-N provided in the air distribution device 300, and has at least one filter cartridge 700-1 to 700-N for purifying air introduced to each specific indoor space and/or air discharged to the outside.

In addition, the filter pressure measuring device 750 is installed on one side of the air purification filter device 700, and has at least one pressure sensor (not shown) for measuring a filter pressure value of each filter cartridge 700-1 to 700-N provided in the air purification filter device 700 by using a pressure of the air introduced to the indoor space and/or the air discharged to the outside.

In general, the pressure sensor may be preferably implemented as a semiconductor pressure sensor, in which the semiconductor pressure sensor is used in devices that need to measure pressure, such as in environments where a vibration significantly occurs or a sudden pressure varies, in a technology field of a sensor part widely used in automobiles, environmental facilities, medical apparatuses, and the like.

As a principle of measuring the semiconductor pressure sensor, a resistance value of the semiconductor changes when a shape of the semiconductor changes in proportion to the pressure applied to the semiconductor. The semiconductor pressure sensor is configured to include a full Wheatstone bridge to which a semiconductor is provided and a voltage is applied. When an external pressure is applied to the full Wheatstone bridge, a resistance value of the semiconductor included in the Wheatstone bridge changes due to a physical bending and the degree of pressure is detected, such that a pressure is measured by attaching a pressure sensor to a surface of an object to be measured whose length changes depending on the pressure.

In addition, the user terminal 800 performs a function of displaying the radon concentration values for each specific indoor space transmitted from the ventilation control device 450 through a pre-installed specific application service, on the display screen by hour and/or date and/or day and/or week and/or month and/or quarter and/or year.

In addition, when the radon concentration value for each specific indoor space transmitted from the ventilation control device 450 through a pre-installed specific application service exceeds a preset risk radon concentration reference value, the user terminal 800 may perform a function of controlling to generate and display a preset radon risk warning message on the display screen according to the radon concentration value for each specific indoor space.

In addition, the user terminal 800 may receive filter contamination level information data classified in advance by grade according to the real-time filter pressure value from the ventilation control device 450 through a pre-installed specific application service, and control to display a filter contamination level value for each filter cartridge provided in the air purification filter device on the display screen by hour and/or date and/or day and/or week and/or month and/or quarter and/or year, based on the filter contamination level information data.

In addition, the user terminal 800 may receive predicted filter contamination level information data classified in advance by grade according to the predicted filter pressure value from the ventilation control device 450 through a pre-installed specific application service, and control to display a predicted filter contamination level value for each filter cartridge provided in the air purification filter device on the display screen by hour and/or date and/or day and/or week and/or month and/or quarter and/or year, based on the predicted filter contamination level information data.

Meanwhile, the user terminal 800 applied to one embodiment of the present invention may be preferably include at least one mobile terminal device of a smart phone, a smart pad, or a smart note that communicate through wireless Internet or portable Internet, and may inclusively signify all wired/wireless home appliances/communication devices having a user interface for accessing the ventilation control devices 450 and/or the server 850, such as personal PCs, notebook PCs, palm PCs, mobile play-stations, digital multimedia broadcasting (DMB) phones with communication functions, tablet PCs, and iPad.

In addition, the server 850 may receive radon concentration information data of each specific indoor space transmitted from the ventilation control device 450, and control to display the radon concentration values for each specific indoor space on the display screen of a separate display device (not shown) by hour and/or date and/or day and/or week and/or month and/or quarter and/or year, based on the radon concentration information data, or control to establish a database (DB) in a separate storage device (not shown).

In addition, the server 850 may receive the radon concentration information data of each specific indoor space measured for a certain period from the ventilation control device 450, and generate an annual standard graph of average radon concentration for each time period for each specific indoor space, based on the radon concentration information data.

In addition, the server 850 may reflect big data information about surrounding meteorological conditions of each specific indoor space managed by the Meteorological Administration management server (not shown) and apply a preset correction index for each environmental element onto the generated annual standard graph of average radon concentration for each time period, thereby calculating an estimated radon measurement value.

In addition, the server 850 may generate a radon concentration prediction graph for each specific indoor space by time, day, month and/or year based on the calculated estimated radon measurement value, and convert the radon concentration prediction graph into a database (DB) to store and manage.

In addition, the server 850 may perform a function of providing a management service to operate a ventilation equipment (not shown) suitable for radon deviation for each specific indoor space according to the generated radon concentration prediction graph for each specific indoor space by time, day, month and/or year.

The ventilation equipment drives one or at least one selected from at least one provided ventilation unit by a specific control signal outputted from the server 850. In addition, the ventilation equipment may include a second external ventilation unit (not shown) serving as a ventilation facility, connected to an outside of one side of a residential space, and connected to an outside of the other side of the residential space to discharge indoor air to the outside or introduce fresh outdoor air into an indoor space, and an indoor ventilation unit (not shown) serving as a ventilation facility installed indoors to discharge the air from the inside or introduce fresh outdoor air after filtering.

In addition, the ventilation equipment may include at least one of the above-described blowing device 150, exhaust fan driving device 200, air supply fan driving device 250, air distribution device 300, exhaust damper driving devices 350-1 to 350-N, air supply damper drive devices 400-1 to 400-N, ventilation control device 450, air purification filter device 700, or filter pressure measuring device 750.

In addition, the server 850 may compare and analyze the calculated estimated radon measurement value with an actual radon measurement value measured from the indoor radon measurement sensor module 101 provided in each indoor radon measurement device 100-1 to 100-N. When it is larger than a preset reference deviation value, the server 850 may perform a function of providing a management service in which a periodic calibrating and diagnosing time for the indoor radon measurement sensor module 101 provided in each indoor radon measurement device 100-1 to 100-N is notified to the user terminal 800 through the communication network 10.

In addition, the server 850 may perform a function of executing a conventional ventilation for discharging radon accumulated in the indoor space.

In addition, the server 850 may perform a function of suppressing radon introduced to the indoor space through a positive pressure by adjusting the supply air amount to be higher than the exhaust amount so as to suppress radon introduced to the indoor space. In other words, when the supply amount of air introduced to the indoor space is greater than the exhaust amount, a slight positive pressure is applied to the indoor space, which can inhibit radon from being introduced to the indoor space.

In addition, since changes of radon in the indoor space depend on external environments and internal lifestyles, the server 850 may perform a function of operating the ventilation equipment while continuously varying the difference between the air supply amount and the exhaust amount.

In addition, the server 850 may perform a function of creating a comfortable indoor environment while reducing indoor radon by increasing both the air supply amount and exhaust amount in the evening.

In addition, the server 850 may operate to minimize the air supply during sleep and stop the exhaust to reduce a noise, thereby minimizing a sleep disturbance, and minimize the inflow of radon into the indoor space through the positive indoor pressure given by variable ventilation.

In other words, the server 850 may perform a function of removing and suppressing radon in the indoor space by changing the air supply amount and the exhaust amount according to a pattern change in radon, without a scheme of simply operating a predetermined amount of ventilation.

In addition, a sensor (not shown) for checking the opening and closing of the front door and the auxiliary door is installed to prevent incomplete closing of a front door and an auxiliary door, which is a problem when a ventilation system using the indoor positive pressure scheme, and the air supply amount is increased more than the exhaust amount for about 1 to 5 minutes after the doors are opened and closed so as to allow the indoor space to have a negative pressure to assist the doors to be opened and closed, so that the incomplete closing of the front door may be minimized.

The exemplary embodiments of the ventilation system for reducing indoor radon concentration according to the above-described present invention have been described. The present invention is not limited thereto, and various modifications can be made within the scope of the claims, the detailed description of the invention, and the accompanying drawings, and also belong to the present invention.

### INDUSTRIAL APPLICABILITY

The present invention may be widely used to a ventilation system for reducing indoor radon concentration.

1. A ventilation system for reducing indoor radon concentration, the ventilation system comprising:
a plurality of indoor radon measuring devices installed in a plurality of specific indoor spaces provided inside a building to measure radon concentration information data of each of the specific indoor spaces;
a blowing device installed on an outer wall of the building or in a specific outdoor place and including an exhaust fan for exhausting air in each specific indoor space and an air supply fan for supplying outdoor air;
an exhaust fan driving device for driving the exhaust fan provided in the blowing device;
an air supply fan driving device for driving the air supply fan provided in the air blowing device;
an air distribution device divided into an upper chamber and a lower chamber and including a plurality of exhaust passages connected to one end of the exhaust fan and accommodating a plurality of exhaust dampers to individually exhaust the air in each specific indoor space to the lower chamber, and a plurality of air supply passages connected to one end of the air supply fan and accommodating a plurality of air supply dampers to supply the outdoor air and individually distribute the outdoor air to each of the specific indoor spaces;
a plurality of exhaust damper driving devices for driving the exhaust dampers to control a flow rate of the air discharged through the exhaust fan from an exhaust port in each specific indoor space in association with a degree of opening of each exhaust passage from full opening to full closing of each exhaust passage stepwise according to a specific ventilation control signal;
a plurality of air supply damper driving devices for driving the air supply dampers to control a flow rate of the air introduced from the air supply fan to an outdoor air supply port in association with a degree of opening of each air supply passage from full opening to full closing of each air supply passage stepwise according to a specific ventilation control signal; and
a ventilation control device configured to control driving of the exhaust fan driving device and the air supply fan driving device, in which the ventilation control device receives radon concentration information data of specific indoor spaces measured from the indoor radon measuring devices in real time, and operates in a primary overall ventilation mode based on the radon concentration information data, when at least one of radon concentration values of the specific indoor spaces is greater than a preset risk radon concentration reference value, to suppress radon introduced to the specific indoor spaces through a positive pressure principle according to a radon concentration value of the corresponding specific indoor space, such that an amount of air introduced into the specific indoor space is adjusted to be higher than an amount of air discharged to an outside, wherein,
after the primary overall ventilation mode is operated, the ventilation control device receives radon concentration information data of the specific indoor spaces measured from the indoor radon measuring devices in real time, analyzes radon concentration changing values for each specific indoor space based on the radon concentration information data, operates in a secondary individual ventilation mode for suppressing radon introduced to each specific indoor space according to radon concentration change values for each specific indoor space, generates a specific ventilation control signal for individually controlling driving of the exhaust damper driving device and the air supply damper driving device to control a flow rate of air introduced to each specific indoor space and a flow rate of air discharged to the outside, and transmits the specific ventilation control signal to the exhaust damper driving device and the air supply damper driving device.

2. The ventilation system of claim 1, wherein each of the indoor radon measuring devices includes:
an indoor radon measurement sensor module installed in each specific indoor space to measure radon concentration information data of each specific indoor space;
a wireless communication module for wirelessly transmitting the radon concentration information data of each specific indoor space measured from the indoor radon measurement sensor module; and
an indoor radon measurement control module configured to control an operation of the wireless communication module, such that the radon concentration information data of each specific indoor space measured from the indoor radon measurement sensor module is received in real time and transmitted wirelessly to the ventilation control device.

3. The ventilation system of claim 2, wherein the indoor radon measurement sensor module includes at least one radon measurement sensor using an ionization chamber scheme.

4. The ventilation system of claim 1, wherein, in the secondary individual ventilation mode, the ventilation control device individually controls driving the exhaust damper driving device and the air supply damper driving device to allow a flow rate of air introduced to each specific indoor space to be adjusted higher than a flow rate of air discharged to the outside, such that radon introduced to each specific indoor space through a positive pressure principle according to a radon concentration change value for each specific indoor space is suppressed.

5. The ventilation system of claim 1, wherein, when a first specific indoor space corresponding to a change value of increasing radon concentration among change values of radon concentration in the specific indoor spaces is present in the secondary individual ventilation mode, the ventilation control device generates a specific ventilation control signal for controlling driving of a first exhaust damper driving device and a first air supply damper driving device corresponding to the first specific indoor space to increase a flow rate of air introduced to the first specific indoor space and decrease a flow rate of air discharged to the outside according to the change value of increasing radon concentration, and when a second specific indoor space corresponding to a change value of decreasing radon concentration among the change values of radon concentration in each specific indoor space is present, the ventilation control device generates a specific ventilation control signal for controlling driving of a second exhaust damper driving device and a second air supply damper driving device corresponding to the second specific indoor space to decrease a flow rate of air introduced to the second specific indoor space and increase a flow rate of air discharged to the outside according to the change value of decreasing radon concentration.

6. The ventilation system of claim 1, wherein, after the primary overall ventilation mode or the secondary individual ventilation mode is operated, the ventilation control device receives radon concentration information data of the specific indoor spaces measured from the indoor radon measuring devices in real time, and controls driving of the exhaust fan driving device and the air supply fan driving device to decrease a current supply amount of air introduced to each specific indoor space and increase a current exhaust amount of air discharged to the outdoors, when the radon concentration value of the specific indoor space is smaller than the preset risk radon concentration reference value, based on the radon concentration information data.

7. The ventilation system of claim 6, wherein, when the radon concentration value of the specific indoor space is smaller than the preset risk radon concentration reference value, the ventilation control device decreases the current supply amount of air introduced to each specific indoor space and increases the current exhaust amount of air discharged to the outdoors, in which the ventilation control device controls driving of the exhaust fan driving device and the air supply fan driving device such that a supply amount of air introduced to each specific indoor space is adjusted to be higher than an exhaust amount of air discharged to the outside so as to suppress radon introduced to each specific indoor space through the positive pressure principle.

8. The ventilation system of claim 1, wherein the ventilation control device is configured to control driving of the exhaust fan driving device and the air supply fan driving device, in which the ventilation control device calculates a time required for at least one of radon concentration values of the specific indoor space to the preset risk radon concentration reference value, and operates in the primary overall ventilation mode, when the calculated required time reaches within a preset reference time range, to suppress radon introduced to each specific indoor space through the positive pressure principle according to the calculated required time, such that a supply amount of air introduced to each specific indoor space is adjusted to be higher than an exhaust amount of air discharged to the outside.

9. The ventilation system of claim 1, further comprising:
at least one heat exchange member provided between the upper chamber and the lower chamber provided in the air distribution device to allow heat exchange between air passing through each exhaust passage and air passing through each supply passage.

10. The ventilation system of claim 1, wherein driving of the exhaust fan driving device and the supply fan driving device is controlled while continuously varying a difference between the supply amount of air introduced to each specific indoor space and the exhaust amount of air discharged to the outside according to the radon concentration value of each specific indoor space.

11. The ventilation system of claim 1, wherein the ventilation control device operates in a night ventilation mode at a preset evening time and controls driving of the exhaust fan driving device and the air supply fan driving device to increase a supply amount of air introduced to each specific indoor space and an exhaust amount of air discharged to the outside by a preset air supply amount and exhaust amount so as to reduce indoor radon and create a comfortable indoor environment.

12. The ventilation system of claim 1, wherein the ventilation control device operates in a sleep ventilation mode at a preset sleeping time, controls driving of the air supply fan driving device to maintain a supply amount of air introduced to each specific indoor space at a preset minimum supply amount, and stops the driving of the exhaust fan driving device to reduce a noise, thereby minimizing a sleep disturbance such that the amount of air discharged to the outside is zero.

13. The ventilation system of claim 1, further comprising:
a display device configured to display radon concentration information data of the specific indoor spaces measured from the indoor radon measuring devices on a display screen, wherein
the ventilation control device receives radon concentration information data of the specific indoor space measured from the indoor radon measuring devices in real time, and controls an operation of the display device such that radon concentration values for each specific indoor space are displayed on the display screen by hour/date/day/week/month/quarter/year, based on the radon concentration information data.

14. The ventilation system of claim 1, further comprising:
a storage device configured to store radon concentration information data of the specific indoor spaces measured from the indoor radon measuring devices, wherein
the ventilation control device receives radon concentration information data of each specific indoor space measured from the indoor radon measuring devices in real time, and controls an operation of the storage device such that radon concentration values for each specific indoor space are established in a database by hour/date/day/week/month/quarter/year and stored in the storage device, based on the radon concentration information data.

15. The ventilation system of claim 1, further comprising:
a communication device configured to transmit radon concentration information data of each specific indoor space measured from each indoor radon measuring device to the outside through wired or wireless communication, wherein
the ventilation control device receives radon concentration information data of the specific indoor spaces measured from the indoor radon measuring devices in real time, and controls an operation of the communication device such that radon concentration values for the specific indoor space are transmitted by wire or wirelessly to an external user terminal or server, based on the radon concentration information data.

16. The ventilation system of claim 15, wherein the user terminal controls to display the transmitted radon concentration values for the specific indoor spaces on a display screen by hour/date/day/week/month/quarter/year through a pre-installed specific application service.

17. The ventilation system of claim 15, wherein, when the radon concentration value for each specific indoor space transmitted through a pre-installed specific application service exceeds a preset risk radon concentration reference value, the user terminal controls to generate and display a preset radon risk warning message on the display screen according to the radon concentration value for each specific indoor space.

18. The ventilation system of claim 1, further comprising:
an air purification filter device installed at a front end or rear end of the exhaust fan or the air supply fan provided in the blowing device, or installed at a front end or rear end of each exhaust damper or air supply damper provided in the air distribution device, and having at least one filter cartridge for purifying air introduced to each specific indoor space or air discharged to the outside; and
a filter pressure measuring device installed on one side of the air purification filter device, and having at least one pressure sensor for measuring a filter pressure value of each filter cartridge provided in the air purification filter device by using a pressure of the air introduced to the indoor space or the air discharged to the outside, wherein
the ventilation control device receives the filter pressure value in real time from the filter pressure measuring device, generates filter contamination level information data classified in advance by grade according to the real-time filter pressure value when the real-time filter pressure value reaches within a preset replacement pressure value range based on the filter pressure value, and controls to transmit the generated filter contamination level information data to an external user terminal or server by wire or wirelessly through a separate communication device.

19. The ventilation system of claim 18, wherein the user terminal receives the filter contamination level information data classified in advance by grade according to the real-time filter pressure value from the ventilation control device through the pre-installed specific application service, based thereon, and controls to display a filter contamination level value for each filter cartridge provided in the air purification filter device on the display screen by hour/date/day/week/month/quarter/year.

20. The ventilation system of claim 18, wherein the ventilation control device calculates a real-time air flow rate value based on real-time rotation speed information of the exhaust fan and the air supply fan provided in the blowing device, and real-time opening degree information of each of the exhaust dampers and each of the supply air dampers provided in the air distribution device, calculates an accumulated air flow rate value by accumulating the calculated air flow rate value in real time, predicts a filter pressure value for a change rate of the accumulated air flow value based on a filter pressure value at an accumulated air flow rate value at a predetermined time, and, when the predicted filter pressure value reaches within a preset replacement pressure value range, controls to transmit the predicted filter contamination level information data classified in advance by grade according to the predicted filter pressure value to the external user terminal or server through the separate communication device by wire or wirelessly.

21. The ventilation system of claim 20, wherein the user terminal receives the filter contamination level information data classified in advance by grade according to the predicted filter pressure value from the ventilation control device through the pre-installed specific application service, based thereon, and controls to display a filter contamination level value for each filter cartridge provided in the air purification filter device on the display screen by hour/date/day/week/month/quarter/year.

22. The ventilation system of claim 18, wherein the ventilation control device calculates a real-time air flow rate value based on real-time rotation speed information of the exhaust fan and the air supply fan provided in the blowing device, and real-time opening degree information of each of the exhaust dampers and each of the supply air dampers provided in the air distribution device, calculates an accumulated air flow rate value by accumulating the calculated air flow rate value in real time, predicts a filter pressure value for a change rate of the accumulated air flow value based on a filter pressure value at an accumulated air flow rate value at a predetermined time, generates filter contamination level information data classified in advance by grade according to the predicted filter pressure value when the predicted filter pressure value reaches within a preset replacement pressure value range, selects one having a higher value between the generated filter contamination level value and the predicted filter contamination level value as a control criterion, executes a weighting mode when the high value between the generated filter contamination level value and the predicted filter contamination level value exceeds a preset reference value, and controls to operate faster than preset operating speeds of the exhaust fan and the air supply fan to compensate for a pressure due to a filter clogging when the radon concentration value for each specific indoor space during execution of the weighting mode is greater than or equal to a preset risk radon concentration reference value.

23. The ventilation system of claim 22, wherein, when the radon concentration value for each specific indoor space during execution of the weighting mode is smaller than or equal to the preset risk radon concentration reference value, the ventilation control device controls to operate slower than preset operating speeds of the exhaust fan and the air supply fan to increase a filter lifespan.
